(19) United States
(12) Patent Application Publication
(10) Pub. No.: US 2002/0134849 A1
(43) Pub. Date: Sep. 26, 2002

(54) Method and apparatus for reducing energy consumption in heating, ventilating, and air conditioning of unoccupied building zones

(76) Inventor: James R. Disser, Oak Ridge, NJ (US)

Correspondence Address: MOSER, PATTERSON & SHERIDAN L.L.P., 595 SHREWSBURY AVE, FIRST FLOOR, SHREWSBURY, NJ, 07702, US

(21) Appl. No.: 10/090,467

(22) Filed: Mar. 4, 2002

Related U.S. Application Data
(60) Provisional application No. 60/272,735, filed on Mar. 2, 2001.

(51) Int. Cl. G05D 23/00; F24F 7/00

(52) U.S. Cl. 236/47; 236/49.3

(57) ABSTRACT

A method and apparatus for controlling heating, ventilation, and air conditioning equipment such that conditioned air supplied to unoccupied building zones is reduced to effect savings in energy. In one embodiment, additional relays are disposed between a thermostat and the heating, ventilation, and air conditioning equipment. Upon detection of a lack of occupancy of a monitored zone, the present invention causes the added relay or relays to open, thereby interrupting the thermostat's ability to maintain a previously defined temperature. In turn, the present invention is then able to vary the temperature of the unoccupied zone to a different temperature setpoint than that of the thermostat.

This application claims the benefit of U.S. Provisional Applications No. 60/272,735 filed on Mar. 2, 2001, which is herein incorporated by reference.

The present invention relates to a method and apparatus for controlling heating, ventilation, and air conditioning equipment such that conditioned air supplied to unoccupied building zones is reduced to effect savings in energy. More specifically, the invention relates a method and apparatus for detecting the presence of people within building zones using a multitude of sensing technologies, such as by measuring the temperature of the air within the zones. Once occupancy of a monitored zone is determined, the present system is able to interface with a variety of mechanical equipment and controls, to change the control setpoint temperatures to user defined time and temperature parameters within the sensed zone that will reduce energy consumption without presenting problems associated with complete disruption of heating, ventilation, and air conditioning or incurring excessive equipment, installation, and replacement costs.

### BACKGROUND OF THE DISCLOSURE

Many buildings employ a thermostat located at one point in the building to control Heating, Ventilation, and Air Conditioning (HVAC) equipment to maintain the temperature of the building at a preset level. The simplest and most inexpensive form of thermostat consists of a thermally operated mechanical switch. The thermostat functions to maintain the preset temperature regardless of the occupancy of the building. While the building is occupied, it is necessary to maintain the temperature at a comfortable level. While it is unoccupied, the temperature of the building can be reduced (if the HVAC system is heating) or increased (while the system is cooling) without any effect on comfort. Such a change can significantly reduce the energy consumed to maintain the building temperature. However, the simple mechanical thermostat is not able to effect this change to bring about energy savings.

A more elaborate thermostat incorporates a clock mechanism and a means to program preset times to change the level of the temperature setting. There exist both mechanical and digital electronic varieties of programmable thermostats that change the temperature control settings at user programmed times. To effect energy savings without sacrificing comfort, the user is required to predict the periods of time when the building will be occupied and unoccupied in the future. In turn, the user will program the thermostat to a comfortable level during the times predicted to be occupied and a reduced level during the predicted unoccupied times. Establishing a program that accomplishes this is difficult due to the variations in the daily habits of people. Variables such as time of day, time of week, even time of year would all need to be predicted and programmed in order for the system to be fully optimized. Elaborate thermostats are available that incorporate sophisticated programming features to accept these predicted variables as well as additional controls and functions to override the user programming, but they often still require frequent user intervention to maintain optimal comfort and energy savings. The cost of the thermostat rises with its complexity as does the skill level required of the user to operate it.

The problem is further exacerbated in attempting to predict the variable habits of a group of people. When predictions are in error, either excess energy is consumed while the building is unoccupied or uncomfortable temperatures are maintained while the building is occupied. In addition, the cost of the programmable thermostat is substantially higher than the simple non-programmable thermostat.

Typically, a building has spaces or zones within it that are both occupied and unoccupied. An example might be an upper floor containing bedrooms during the day, or a conference room in an office building. These zones are typically not occupied at times when other zones are occupied. Each zone in a building can be controlled individually by a separate thermostat. Some energy savings can be realized by attempting to utilize programmable thermostats in each zone. The problems associated with the prediction of occupancy are still encountered and in fact are compounded due to the increased complexity of predicting occupancy in a variety of zones.

More sophisticated thermostats can be employed, but at an increased cost. In fact, the cost and installation of a central zoning control panel may be required, in addition to the cost of the thermostats. The increased cost and complexity of the system and its installation combined with the limitations of the programmable thermostat in maintaining optimal control based on predicted occupancy, present a barrier that can prevent the system from being effective at reduction of energy consumption.

Thus, there is a need in the art for a simple to operate and economical device that can reliably detect the presence of people within building zones that can be integrated with existing controls, to reduce the flow of conditioned air into the buildings zones based upon occupancy.

### SUMMARY OF THE INVENTION

The present invention is a method and apparatus for controlling heating, ventilation, and air conditioning equipment such that conditioned air supplied to unoccupied building zones is reduced to effect savings in energy. In one embodiment of the present invention, additional relays are disposed between a thermostat and the heating, ventilation, and air conditioning equipment. Upon detection of a lack of occupancy of a monitored zone, the present invention causes the added relay or relays to open, thereby interrupting the thermostat's ability to maintain a previously defined temperature. In turn, the present invention is then able to vary the temperature of the unoccupied zone to a different temperature setpoint than that of the thermostat.

For example, if the thermostat is preset to be 75° Fahrenheit during business hours of 8:00 AM to 5:00 PM, and 65° Fahrenheit for the rest of the day, and the occupant leaves for a meeting at 9:00 AM and returns at 3:00 PM, the present invention will interrupt the HVAC system such that it will not be able to maintain the 75° Fahrenheit when the room is not occupied. Instead, the temperature will be set to a different setpoint than that of the thermostat, e.g., 70° Fahrenheit, until occupancy of the room is again detected. In other words, when the room temperature falls below 70° Fahrenheit, the added relay or relays will be closed, thereby allowing the HVAC system to attempt to reach 75° Fahrenheit. If the room remains unoccupied, the present invention will again interrupt the HVAC system when the room temperature reaches 70° Fahrenheit, whereas if the room becomes occupied, the present invention will allow the HVAC system to reach 75° Fahrenheit as preset by the thermostat. The energy savings in changing the temperature by 5° Fahrenheit for many hours throughout the day will be very significant, especially when compounded throughout a large office building.

In a second embodiment of the present invention, upon detection of a lack of occupancy of a monitored zone, the present invention instead varies the temperature set for the monitored zone, by controlling motorized dampers directly, e.g., closing the vent, such that conditioned air is not provided to the monitored zone. However, if the room becomes occupied at a later time, the motorized dampers are again operated directly, e.g., opening the vent, such that conditioned air is provided to the monitored zone. As in the case above, the present invention can be programmed such that the damper is periodically operated to maintain a different setpoint than that of the thermostat when the room is not occupied.

It should be noted that the present invention can be deployed locally to reduce energy consumption without the need for a central zoning controller or a building controller. In fact, its ease of use eliminates the need to predict and program the occupancy of the buildings zones, thereby allowing its deployment with current thermostats.

Finally, the present invention employs one or more occupancy detection devices to reliability sense the occupancy of a monitored zone. These occupancy detection devices include a motion sensing device, a light sensing device, and an acoustic sensing device. These occupancy detection devices can all be employed in the present invention or in some different subset combinations to meet different application requirements.

### BRIEF DESCRIPTION OF THE DRAWINGS

The teachings of the present invention can be readily understood by considering the following detailed description in conjunction with the accompanying drawings, in which;

FIG. 1 illustrates a block diagram of the apparatus of the present invention;

FIG. 2 illustrates the electrical circuit used to interface the invention with HVAC equipment;

FIG. 3 illustrates the electrical circuit used to interface the invention with thermostats used in HVAC control;

FIG. 4 illustrates the circuit used by the invention to control motorized dampers;

FIG. 5 illustrates an interface architecture where the present invention is used within a single zone HVAC system employing a thermostat;

FIG. 6 illustrates an interface architecture where the present invention is used to create multiple zones controlled independently in an HVAC system using a single thermostat; and

FIG. 7 illustrates an exploded assembly drawing of the major assemblies and components of the present invention.

To facilitate understanding, identical reference numerals have been used, where possible, to designate identical elements that are common to the figures.

### DETAILED DESCRIPTION

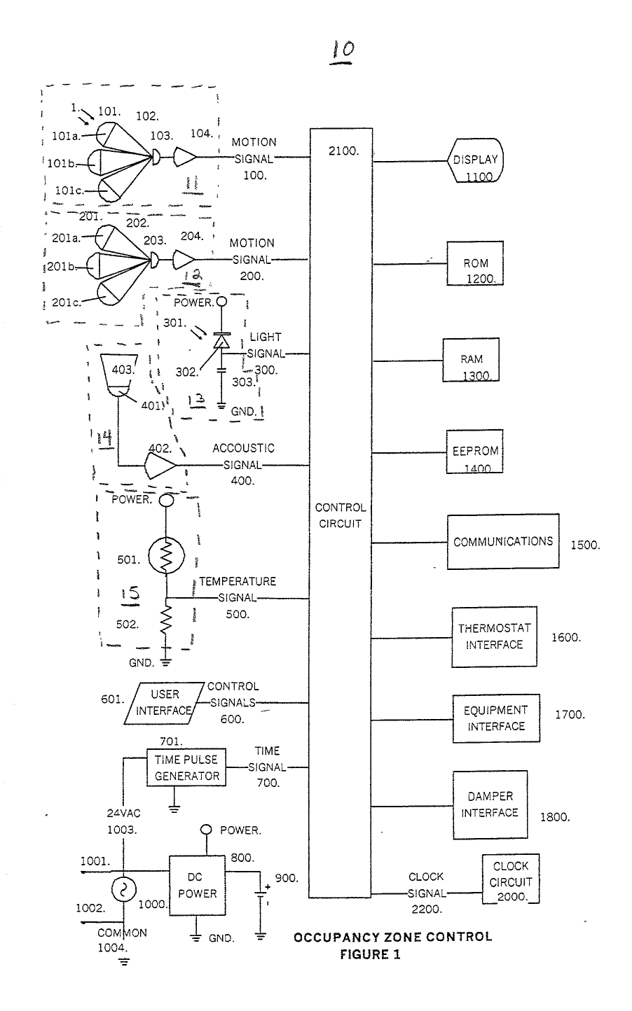

FIG. 1. depicts a block diagram of the present energy reducing apparatus or system 10 that is designed to detect occupancy of a monitored zone. It should be noted that the term “monitored zone” may include a single room or a plurality of rooms. The energy reducing apparatus or system 10 can be deployed to operate with existing HVAC systems that employ a thermostat, thereby extending simple HVAC system with the ability to detect occupancy of a monitored zone.

In one embodiment, the present energy reducing apparatus or system 10 comprises a control circuit 2100, a plurality of occupancy detection devices (e.g., one or more motion sensing devices 11 and 12, a light sensing device 13, and an acoustic sensing device 14), a temperature sensing device 15, input/output devices (e.g., an user interface 601 and display 1100), storage devices, (e.g., read only memory (ROM) 1200, random access memory (RAM) 1300, and (EEPROM) 1400), a timing circuit (e.g., time pulse generator 701 and clock circuit 2000) and a plurality of interfaces (communication interface 1500, thermostat interface 1600, equipment interface 1700, and damper interface 1800). It should be noted that although FIG. 1 illustrates an energy reducing apparatus or system 10 that has a plurality of capabilities, those skilled in the art will realize that system 10 can be deployed with only a subset of those capabilities to meet the requirements of a particular application.

In brief, motion, acoustic, time and light signals can all be processed by the integrated digital control circuit 2100 in combination with random access memory, programmable read only memory, electrically erasable programmable read only memory (EEPROM), user interface circuits, communication, and display circuits. The control circuit 2100 executes a control algorithm that is stored as machine code in ROM memory. It uses the RAM to temporarily store variable information and EEPROM memory to permanently store configuration and historical information. The control circuit can be programmed with a variety of algorithms to optimize the functionality of the present invention for the purpose of reducing energy consumption while providing a means for the user to modify the behavior of the control to suit his preference. For example, the user may desire that the temperature in a zone be brought back to the setpoint of a thermostat at a particular time regardless of the state of occupancy. The user using the interface and display circuits can program such a behavior. The control circuit 2100 can execute the desired pattern by utilizing the time signal incorporated in the invention. More sophisticated algorithms can be executed that utilize historical information to spot patterns in occupancy in order to improve the reliability of the decisions made by the device. Such historical data could be stored in the EEPROM memory. For example, if historical data indicate that typically the monitored zone is not occupied during periods of darkness and an occupancy signal is subsequently detected, an increased duration of the occupancy signal can be required by the control algorithm to confirm that the occupancy detection is proper, since none would be expected.

In the preferred embodiment, control circuit 2100, ROM 1200, RAM 1300, communication circuit 1500, and clock circuit 2000 are contained in an integrated circuit, e.g., from Microchip part number PIC16F72. The integrated microcontroller circuit additionally provides input and output connections, an integrated multiplexed analog to digital converter, timers, and counters, and other circuits typically found in such devices. While this component suits the preferred embodiment of the control circuit, other methods of construction for the control circuit 2100 can be utilized by persons skilled in the art such as custom integrated circuits or programmable logic circuits in combination with external discrete integrated circuits and other electronic components. Thus, the invention can be constructed in a variety of ways and yet still provide the functional elements as described in FIG. 1.

The control circuit 2100 is capable of executing a sequence of instructions described by digital codes stored in ROM 1200 or contained in the structure of a custom or programmable integrated circuit. The structure or code enables the control circuit 2100 to execute the control algorithm by means of a set of logical operations executed in series or parallel and sequenced by clock signal 2200, e.g., as provided by the clock circuit 2000.

The user interface circuit 601 provides a means (e.g., a key pad or buttons) for an operator to input control signals 600 to the control circuit 2100. These control signals 600 can be utilized by the control circuit 2100 in a variety of ways to start, stop, or change the execution of the control algorithm. The control circuit 2100 can in response communicate with the user, under the direction of the control algorithm, by means of the display 1100. The display can consist of a variety of indicators ranging from light emitted diode (LED) lamps to liquid crystal alphanumeric displays, and could also include audible indicators such as buzzers or speakers (not shown). During normal operation, the display can communicate other information such as temperature measurements, energy usage, status of the control circuit, or any other information available to the control circuit 2100.

The EEPROM circuit 1400 provides a means to store information in the event power is lost and the content of RAM 1300 is lost. Such stored information could consist of user entries to configure the operation of the control circuit 2100, or historical information such as the pattern of motion, light, and acoustic activity sensed over a period of time. Such information could be used by the control algorithm to modify the behavior of the control in such a manner as to improve the reliability of detection or execute system commands at preset times entered by the user. Historical information could also be used to allow the control circuit 2100 to adapt the control algorithm to the occupancy patterns sensed.

The communications circuit 1500 provides a means for the control circuit 2100 to transmit and receive data from an outside or remote source. Namely, it may be desirable for energy reducing apparatus or system 10 to be accessible remotely, e.g., from a central building monitoring station or from a control station that is offsite from the building. Such data could consist of commands to the control circuit 2100 to execute test algorithms for diagnostics of the device or to actuate various interface circuits. In fact, the communications circuits can be constructed to interface the device to any number of different communication hardware and software protocols to execute commands, display information, alter the behavior of the control algorithm or transmit commands and data to and from other devices. These communication circuits could include, but are not limited to, ethernet, RS-232, RS-485, USB, and proprietary standards and can transmit information over a variety of transmission media such as light, wire, radio or sound waves.

An external AC power source 1000 is connected to the circuit assembly by means of connectors 1001,1002. Typically, HVAC equipment provides a 24 volt AC supply derived from 120 Volt 60 HZ power mains by means of an external transformer (not shown). Such a supply circuit could be incorporated into the present system without changing the function of the device. The 24 Volt AC signal 1003 is passed to a time pulse generation circuit 701 that conditions the signal and generates a digital time signal 700 in the form of a pulse train. Time signal 700 can be used, when present, by control circuit 2100 to measure the passage of time by means of counting the received pulses. Time interval measurements required for the execution of the control algorithm can be derived from time signal 700 in such a manner.

24 VAC power 1003 is also passed to DC power circuit 800. DC power circuit 800 rectifies, filters, fuses, and otherwise conditions 24 VAC power 1003 into a stable, regulated power supply. Battery 900 provides backup power to maintain the circuit operation in the event AC power 1000 is interrupted.

To sense the presence of people in the monitored zone, the present invention incorporates a multitude of sensing devices or systems. One type of sensing system employed is a motion sensing system. In brief, the system consists of a multi element lens to focus thermal energy onto a detector from a multitude of areas within the monitored zone. The detector is sensitive to the blackbody wavelengths typically emitted by room and body temperature objects. A moving object such as a person produces variations in the amount of thermal radiation reaching the detector as the person passes through the areas in focus. The detector responds to the variations in thermal radiation by producing a varying electrical signal. An electrical circuit filters and amplifies the electrical signal from the detector and outputs the signal to the integrated digital control circuit 2100. The control circuit 2100 employs analog to digital conversion circuitry to further condition the motion signal to a digital form for use in the control algorithm executed by the control circuit. The present invention may in fact use a multitude of motion sensing systems to provide a more extensive coverage area or increase the density of coverage to improve the sensitivity of the motion sensing system.

The present energy reducing apparatus or system 10 employs one or more occupancy detection devices. The signals generated by these occupancy detection devices are broadly defined as occupancy signals. In one embodiment, a motion sensing device 11 or 12 is deployed to detect the occupancy of a monitored zone.

The motion sensing device 11 comprises a lens 101, a pyroelectric detector 103 and a signal processing circuit 104. In operation, infrared radiation signals 1 produced by thermal radiation emitted by people and objects are focused by lens 101. In the preferred embodiment, lens 101 is a precision molded plastic multi element lens, e.g., as supplied by Fresnel Technologies inc. part number CM 0.77 GI V2. The lens consists of a number of lens elements illustrated by 101a, 101b, 101c with each focused in a different direction. Thus, the multiple elements of the lens 101 increase the region of space within which radiation signals 1 can be detected. In fact, any number of lens elements can be incorporated into the molded lens. There are advantages in increasing the number of lens elements and thus the density of sensitive areas within the zone.

The focused radiation 102 signals strike pyroelectric detector 103. In the preferred embodiment, the detector used is an EG&G part #LHI 1448. This detector contains twin inter-digitated pyroelectric detector elements that serve to increase the sensitivity to small movements by increasing the density of sensitive detection area. The detector combines the detection elements with amplification circuitry and optical filters. The detector 103 converts variations in the radiation signal 1 into varying voltage signals that are conditioned with amplification and filtration in the signal processing circuit 104. The signal processing circuit 104 increases the magnitude of the frequency components of interest and produces the motion signal 100. The motion signal 100 is of sufficient magnitude and quality as to provide an accurate representation of the changes detected in the radiation signal 1 such that it can be accepted for processing by the control circuit 2100. The signal processing circuit 104 is constructed such that signal variations produced by human movements are preferentially amplified and background signals are filtered out.

In the preferred embodiment, the control circuit 2100 can process a number of motion signals. FIG. 1 depicts a second motion sensing device 12 for generating a second motion signal 200. In fact the control circuit 2100 can be constructed to accept any number of motion signals. Since the control parameter of the present invention is based on occupancy, it is important to ensure that occupancy of a monitored zone is properly measured. Namely, the system 10 must be sure that a monitored zone is really unoccupied before conditioned air is stopped from being delivered to the monitored zone. Otherwise, a user will be frustrated if conditioned air is terminated while he or she is still present in the monitored zone.

Returning to FIG. 1, lens 201 is directed toward a different region of space than lens 101 and thereby increases the size of the zone in which human motions can be sensed. Control circuit 2100 digitizes motion signals 100 and 200. The digitized signals are compared in amplitude and frequency to signatures that indicate the radiation signals 1 detected were produced by human movement. Such a signature could be represented by the detected signal amplitude crossing above and below a set of reference voltages a preset number of times within a fixed period of time as measured from the first signal crossing. The control circuit 2100 as desired could execute other signature analysis algorithms. Thus, motion signals 100 and 200 provide control circuit 2100 with an accurate indication that human presence has been sensed and that the zone defined by the region of space through which the radiation signals 1 can pass and be focused onto detectors 103 and 203 is occupied.

To further enhance the ability of the present invention to detect occupancy, a light sensing system is employed. In brief, light is diffused by the optical system (e.g., lens) and is received by a photoelectric detector. An integrating circuit collects the photocurrent generated by the light level in the zone. The integration circuit converts the photocurrent into a voltage signal proportional to the average light level during the integration time of the system. The voltage signal is outputted to the integrated digital control circuit 2100 where it is further conditioned by an analog to digital converter. The digital light signal is then utilized in the control algorithm. Light levels provide a means for the control circuit 2100 to sense the time of day and the presence of and change in artificial lighting levels.

Specifically, the light sensing device 13 comprises a capacitor 303 and a photoelectric detector 302. In operation, light signals 301 are diffused by lens 101, 201 and are detected by the photoelectric detector 302. A photocurrent is generated by the light and integrated in capacitor 303. The integrated charge creates light signal 300 in the form of a voltage proportional to the light intensity and integration time. Control circuit 2100 controls the operation of the integrating capacitor by alternately discharging and allowing the capacitor to charge by the photocurrent for a predetermined amount of time. Once the charging period has elapsed, the light signal is sampled and digitized in the control circuit and the cycle is repeated. While this light sensing circuit 13 will provide light signal 300, other light sensing circuits will provide equally suitable light signals and can be substituted for the preferred embodiment described. Light signal 300 provides the control circuit 2100 with information about the conditions surrounding the system 10. Specifically, high levels of light that vary slowly over time indicate daylight, while lower levels of light varying at 60 HZ, or 120 HZ indicate the presence of artificial lighting. This information can be used by the control algorithm to improve the reliability of the detection of occupancy.

For example, if the monitored zone has been dark for an extended period of time and then is suddenly illuminated by an artificial source while at the same time motion has been sensed, the reliability of the decision that a person is present is increased, i.e., it being less likely that the motion was created by an animal or an inanimate object. Additionally, the present invention can be programmed to detect the actuation occupancy controlled lighting systems to further increase the reliability of detection.

To further enhance the ability of the present invention to detect occupancy, the present invention employs an acoustic sensing system. In brief, the system consists of a microphone element, an acoustic cavity and an amplification and filter circuit. Sound reaching the system is conducted by an acoustical cavity onto the microphone element and is converted into a time varying electrical signal. This signal is fed to the integrated digital control circuit 2100. An analog to digital conversion circuit further conditions the signal for processing by the control algorithm. Certain time and frequency signatures in the sound signal can be attributed to human speech, breathing, or movement. The detection of these signatures by the present invention serves to increase the reliability of the decision that a person is present when used in combination with the other signals sensed.

Specifically, the acoustic sensing device 14 comprises an acoustical chamber 403, a sound transducer 401 and a signal conditioning circuit 402. In operation, sound reaching the acoustical chamber 403 is conducted toward the sound transducer 401. The signal conditioning circuit 402 amplifies and filters the signal received from the transducer and generates the acoustic signal 400. The control circuit 2100 periodically samples the acoustic signal 400 and digitizes the samples. The control circuit 2100 further processes the samples to digitally filter the acoustic signal in order to determine the power and frequency spectrum contained within it. The power and frequency spectrum is compared to various signatures to search for a match to a signature characteristic of sounds produced by humans. Such signatures could include speech, breathing, snoring, or walking. If a match occurs, the control algorithm can utilize this fact to increase the probability of occupancy. Such a factor can be combined with other factors from the analysis of motions and light to produce an overall probability of occupancy. When the probability exceeds a predetermined or user controlled level, the control algorithm can execute the control functions associated with occupancy.

For example, if the zone has been dark for an extended period of time and then is suddenly illuminated by an artificial source while at the same time motion has been sensed and a sound containing frequencies typical of human speech is detected, the probability that the combination of signals received was created by an animal or inanimate object is greatly reduced. If no motion or light is sensed, but sounds containing the signature related to breathing or snoring is sensed, there is an indication that the zone is occupied that would otherwise go undetected by a system that incorporates only a single sensing system such as motion.

The present invention also incorporates a temperature sensing circuit. In brief, this circuit converts the air temperature within the monitored zone to an electrical signal that is output to the integrated digital control circuit 2100. The temperature signal is digitized by an analog to digital converted within the control circuit. The control algorithm utilizes the digitized temperature signal to effect control of the air temperature by the actuation of a variety of interface circuits which connect the present invention to the HVAC equipment that produces and controls the flow of conditioned air.

Specifically, the temperature sensing device 15 comprises a thermistor 501 and a resistor 502. In operation, airflow from the building passes through the opening 4003 of the system 10 (shown in FIG. 7 below) and forces the thermistor 501 to reach an equilibrium with the temperature of the room that it is contained in. Resistor 502 forms a voltage divider that produces a nearly linear voltage signal proportional to the equilibrium temperature of the thermistor 501. This voltage temperature signal 500 is passed to the control circuit 2100. Control circuit 2100 uses a switching circuit (not shown) to stop the flow of current in thermistor 501 until such time as a measurement is required. When a measurement is required, current is allowed to flow in the thermistor 501 and a sample of the temperature signal is taken and digitized. Once sampled, the current is once again stopped to prevent an error caused by resistive self-heating in the thermistor. While this temperature sensing circuit 15 will provide temperature signal 500, other temperature sensing circuits will provide equally suitable temperature signals and can be substituted for the preferred embodiment described. The control algorithm utilizes the temperature signal to allow the control circuit to actuate the interface circuits 1600, 1700, and 1800 such that the room temperature is maintained at set back levels (i.e., a level that is different that a level that is set on the thermostat of the HVAC system) that require less energy to maintain while the area sensed by the invention is not occupied.

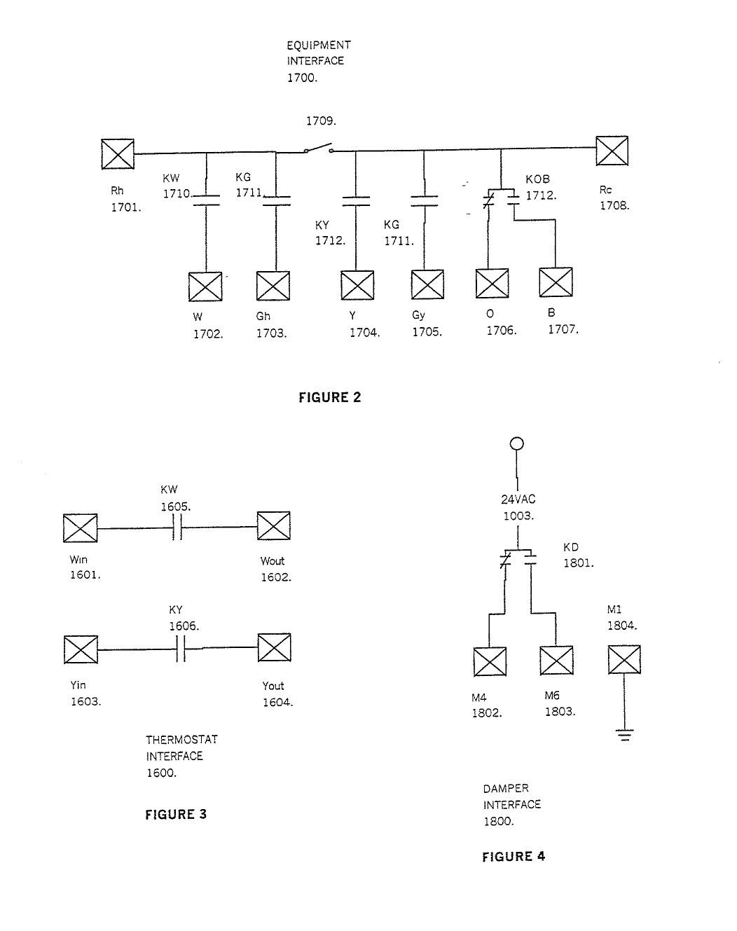

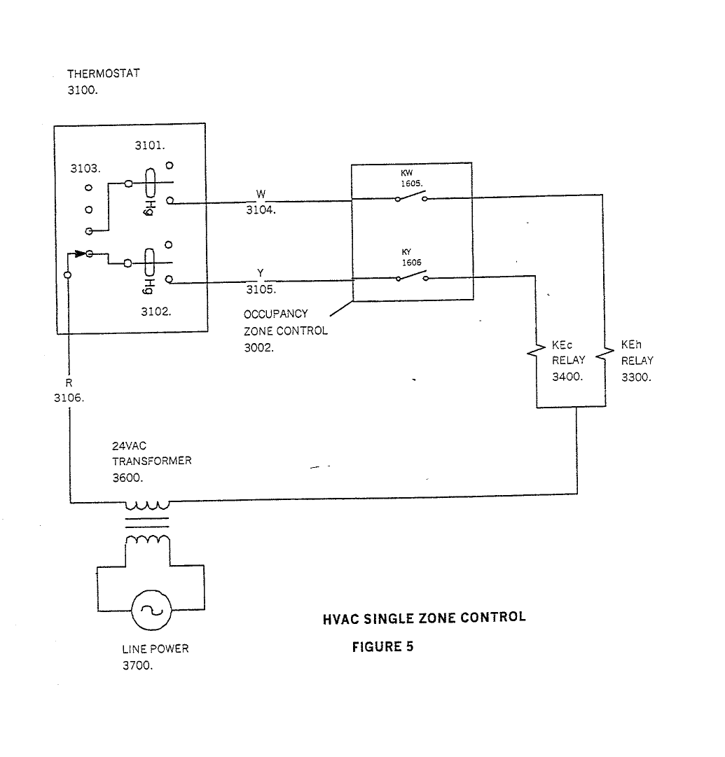

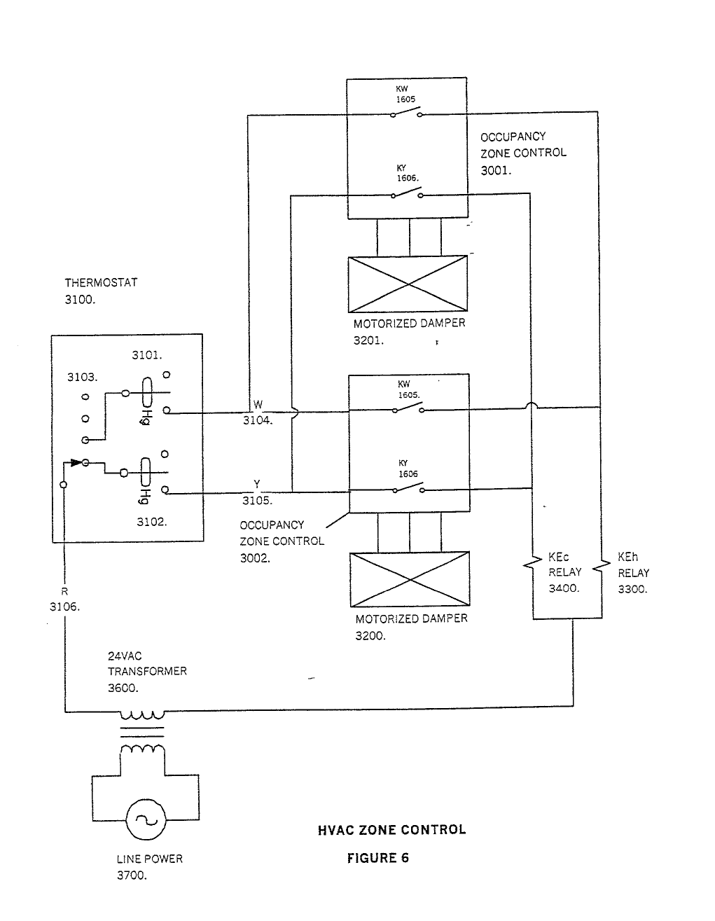

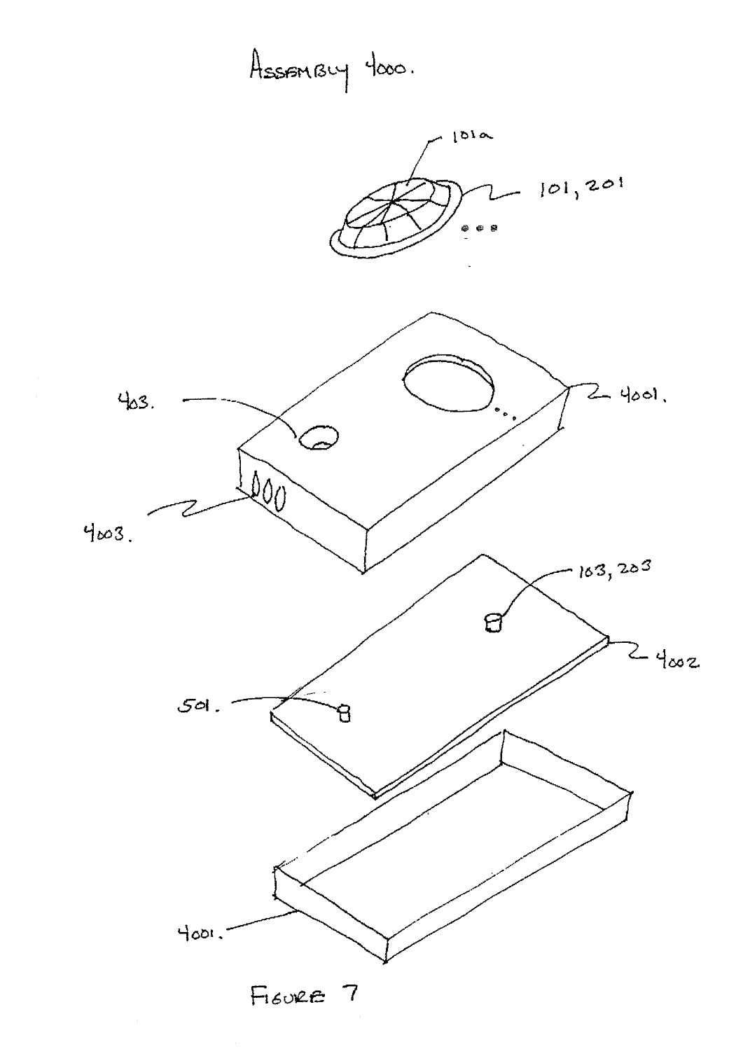

FIG. 2 illustrates the wiring of a set of relay contacts to form an HVAC equipment interface circuit 1700. The control circuit can energize relays KW 1710, KG 1711, KY 1712, and KOB 1712. The contact wiring provides a switching circuit that can energize control relays in typical HVAC equipment to control the operation of the equipment. Additionally, FIG. 2 illustrates a standard set of thermostat terminals that can be wired to replace a thermostat, e.g., thermostat 3100 (as shown below in FIGS. 5 and 6) and to operate the HVAC equipment directly in the event the occupancy detection features of the device are desired in systems that employ conventional zoning technology.

FIG. 3 illustrates the wiring of a set of relay contacts to interface to a typical mechanical thermostat. Namely, a relay contact 1605 is disposed between a first connection point Win 1601 and a second connection point Wout 1602. Similarly, a relay contact 1606 is disposed between a first connection point Yin 1603 and a second connection point Yout 1604. For example, Win 1601 and Wout 1602 may represent a heating circuit, whereas, Yin 1603 and Yout 1604 may represent a cooling circuit. This relay architecture is further elaborated in FIG. 5.

The present invention provides an interface circuit that consists of a set of mechanical contacts to reduce energy consumption. These contacts are wired in series with the contacts typically found in a thermostat in the heating, ventilation, and air conditioning equipment control circuit. While a monitored zone is occupied, the contacts in the interface circuit are closed and the thermostat in the zone functions normally to maintain the temperature at the setpoint of the thermostat. When the present invention senses that the monitored zone is no longer occupied, the contacts in the interface circuit are opened. The zone thermostat is temporarily disabled in the sense that it is unable to control the HVAC equipment, and the temperature in the zone deviates from the thermostat setpoint. The present invention will allow the temperature of the room to reach a level defined by the user for “unoccupancy” and then closes the interface circuit contact to activate the flow of conditioned air, i.e., returning control to the thermostat. Since the temperature of the room is outside of the thermostat setpoint, the thermostat will attempt to bring the temperature of the zone to its setpoint. However, the present invention is designed to allow the temperature to be set to a different setpoint if the monitored zone is unoccupied, while the thermostat switch remains closed given that the two contacts are wired in series. This novel interface circuit allows the present invention to reduce the frequency that the thermostat requests conditioned air by periodically disabling the thermostat and provide energy savings without the need to replace the existing thermostat control system in the monitored zone. The present interface allows the present invention to be placed remotely from the thermostat and avoids problems with coverage of the zone that can occur when placement of the sensing system is restricted.

More specifically, FIG. 5 illustrates an interface architecture that a monitored zone control 3002 described in these teachings can use contacts 1605 and 1606 to interface with the thermostat and actuate the equipment relays Kec 3400 and Keh 3300. Transformer 3600 provides 24 VAC power to the R 3106 terminal of the thermostat 3100. A selector switch 3103 in the thermostat selects either the heating circuit W 3104 or the cooling circuit Y 3105. Mercury switches 3101 and 3102 make contact when the air temperature is outside the limit of the switch. If the control algorithm within control circuit 2100 indicates the monitored zone 3002 is occupied, the control circuit 2100 will energize the KW relay 1605 and/or the KY relay 1606. The KW relay 1605 will have no effect as illustrated in FIG. 5, since the selector switch 3103 is set to the cooling circuit in the position shown. The KY relay 1606 will allow the Kec relay 3400 to energize and the temperature will decrease to the point that the mercury switch 3102 opens.

However, if the control algorithm within control circuit 2100 determines the monitored zone is unoccupied, it will de-energize the KW 1605 and/or Ky 1606 relays. When these contacts are opened, the temperature will rise due to the fact that the mercury switch 3102 cannot complete the circuit to energize the Kec 3400 relay. The present invention will allow the temperature to continue to rise until it reaches a programmed setpoint for an unoccupied zone. If the temperature reaches the programmed setpoint for an unoccupied zone, the control circuit 2100 will then energize the relays 1605 and/or 1606 and the temperature will again drop. However, the control circuit will only allow the temperature to drop below the programmed setpoint for an unoccupied zone, but not enough to open the mercury switch 3102. The relay contact KY 1606 will then open and again allow the temperature to rise. Namely, the effect of this control is to raise the temperature and hold it at a point higher than the thermostat set point while the zone is not occupied to reduce the flow of conditioned air and the energy consumed by the HVAC system. The system will function in a similar manner if the selector switch is placed to activate the W 3104 circuit. Of course, the control algorithm will use a temperature lower than the thermostat set point in this “heating” case.

A second interface circuit of the present invention provides control signals to a motorized mechanical damper. The damper restricts the flow of conditioned air into a monitored zone when closed and allows it to flow when open. The present invention opens the damper during the periods when the monitored zone is occupied and intermittently closes it when it is not. By is closing the damper, the present invention prevents the flow of conditioned air into an unoccupied zone and reduces the load on the HVAC system. In one embodiment, the invention does allow some conditioned air to flow into the monitored zone while it is unoccupied to maintain the temperature in the zone to the user setpoint which can be programmed to provide ventilation periodically. The reduction in load reduces the amount of energy consumed to condition the air in the entire building. This circuit architecture allows the present invention to be added to a building with no additional changes required to the thermostatic control system in the building. The present invention allows the building to be divided into multiple occupancy zones. Reducing the flow of conditioned air to zones that are unoccupied greatly reduces energy consumption. The utilization of occupancy detection within the monitored zone represents an improvement over programmable thermostat techniques due to the complexity and unpredictable nature of human behavior and the problems associated with attempting to predict that behavior while programming a thermostat. Complete stoppage of airflow and temperature control would allow for the possibility that the temperature in the zone reaches uncomfortable or possibly dangerous levels. The ability of the present invention to regulate the temperature represents an improvement over simple occupancy sensors having no temperature control capability that may stop the flow completely.

More specifically, FIG. 4 illustrates an interface circuit to control a standard commercial motorized damper such as a Honeywell Trol-A-Temp model 8X10AOBD. 24 VAC power 1003 is applied to terminal M4 1802 or M6 1803 depending on the state of the damper control relay KD 1801. The power supplied by either terminal flows through the damper motor mechanism to cause it to either open or close and returns to terminal M1 1804. Thus, the present invention can control the position of the motorized damper. The circuit is also capable of control of a two wire spring return damper such as a Honeywell Trol-A-Temp 8MARD by wiring to the appropriate terminals.

More specifically, FIG. 6 depicts a multiple zone system controlled by one thermostat 3100 and multiple occupancy zone controls 3001, 3002 as described in the teachings of the present invention. The occupancy zone controls 3001, 3002 function as described above to control the equipment relays KEc 3400 and KEh 3300. Either zone control can provide a path to complete the circuit to energize an equipment relay. In addition to controlling the HVAC equipment, the present invention can also function to control a motorized damper 3201 or 3200. If the monitored zone sensed by occupancy zone control 3201 is occupied, it will open its damper 3201 using the damper interface circuit 1800. In turn, the damper 3200 will be closed when the zone covered by occupancy zone control 3002 is unoccupied. When thermostat 3100 calls for conditioned air, it will flow into the zone regulated by open damper 3201 but will be prevented from flowing into the zone regulated by closed damper 3200. The effect will be to cut the load imposed by unoccupied zones out of the total load on the HVAC equipment, thereby reducing the energy consumption required to condition the air in the overall building. Any number of occupancy zone controls can be wired to the circuit. The occupancy zone controls are wired into the existing control system and do not require replacement or additional controls to provide zoning.

FIG. 7 depicts an exploded view of the construction assembly 4000 of the embodiment of the invention. Specifically, the embodiment is an illustrative assembly 4000 that contains a printed circuit assembly 4002 that is comprised of a control circuit 2100, that receives one or a number of motion signals 100, 200, a light signal 300, an acoustic signal 400, a temperature signal 500, control signals 600, and a time signal 700. The control circuit 2100 is connected to a display 1100, a Read Only Memory (ROM) 1200, a Random Access Memory (RAM) 1300, an Electrically Erasable Programmable Read Only Memory (EEPROM) 1400, a communications circuit 1500, a thermostat interface circuit 1600, an equipment interface circuit 1700, a damper interface circuit 1800, and a clock circuit 2000. All of the circuitry is powered by an AC power source 1000, a DC power circuit 800 provides DC power to the circuitry. A battery 900 also provides power in the event the AC power source 1000 is not available. The printed circuit assembly 4002 is contained in a molded plastic enclosure 4001. The molded enclosure also serves to position the lenses 101 and 201 relative to the pyroelectric detectors 103 such that the detectors are located at the common focal point of the lenses 101, 201. The molded plastic enclosure 4001 also serves as the acoustic chamber 403. The enclosure provides a means, in the form of ventilation 4003 for unobstructed airflow over temperature sensor 501 in such a manner as to prevent drafts from reaching the sensitive detectors 103, and 203.

It should be noted that the above invention was described in terms of opening a relay or relays to effect interruption of a thermostat. However, those skilled in the art will realize that depending on the specific manner of deployment of the HVAC system and the thermostat (or other equipment), it may be appropriate to close the relay or relays to effect interruption of a thermostat.

Additionally, the above invention is described in terms of a HVAC system, i.e., heating and cooling. However, those skilled in the art will realize that the present invention can be deployed in a system having only heating, cooling or simply ventilation or combination thereof.

Although various embodiments which incorporate the teachings of the present invention have been shown and described in detail herein, those skilled in the art can readily devise many other varied embodiments that still incorporate these teachings.

What is claimed is:

1. An apparatus for reducing energy consumption, said apparatus comprising:
at least one occupancy detection device for generating an occupancy signal that is representative of an occupancy of a monitored zone;
at least one relay for being disposed along a heating, ventilation or cooling circuit, where said circuit includes a thermostat having a thermostat setpoint; and
a control circuit, coupled to said at least one occupancy detection device, for receiving said occupancy signal and for causing said at least one relay to interrupt operation of said thermostat if said occupancy signal indicates that said monitored zone is unoccupied.

2. The apparatus of claim 1, further comprising a temperature circuit, coupled to said control circuit, for detecting a temperature setpoint that is different from said thermostat setpoint.

3. The apparatus of claim 2, wherein said at least one occupancy detection device comprises a first motion sensing device.

4. The apparatus of claim 3, wherein said at least one occupancy detection device comprises a second motion sensing device.

5. The apparatus of claim 2, wherein said at least one occupancy detection device comprises a light sensing device.

6. The apparatus of claim 3, wherein said at least one occupancy detection device further comprises a light sensing device.

7. The apparatus of claim 2, wherein said at least one occupancy detection device comprises an acoustic sensing device.

8. The apparatus of claim 3, wherein said at least one occupancy detection device further comprises an acoustic sensing device.

9. The apparatus of claim 5, wherein said at least one occupancy detection device further comprises an acoustic sensing device.

10. The apparatus of claim 6, wherein said at least one occupancy detection device further comprises an acoustic sensing device.

11. A method for reducing energy consumption, said method comprising the steps of:
a) providing at least one occupancy detection device for generating an occupancy signal that is representative of an occupancy of a monitored zone;
b) providing at least one relay for being disposed along a heating, ventilation or cooling circuit, where said circuit includes a thermostat having a thermostat setpoint; and
c) providing a control circuit for receiving said occupancy signal and for causing said at least one relay to interrupt operation of said thermostat if said occupancy signal indicates that said monitored zone is unoccupied.

12. The method of claim 11, further comprising the step of:
d) providing a temperature circuit for detecting a temperature setpoint that is different from said thermostat setpoint.

13. The method of claim 12, wherein said at least one occupancy detection device comprises a first motion sensing device.

14. The method of claim 13, wherein said at least one occupancy detection device comprises a second motion sensing device.

15. The method of claim 12, wherein said at least one occupancy detection device comprises a light sensing device.

16. The method of claim 13, wherein said at least one occupancy detection device further comprises a light sensing device.

17. The method of claim 12, wherein said at least one occupancy detection device comprises an acoustic sensing device.

18. The method of claim 13, wherein said at least one occupancy detection device further comprises an acoustic sensing device.

19. The method of claim 15, wherein said at least one occupancy detection device further comprises an acoustic sensing device.

20. The method of claim 16, wherein said at least one occupancy detection device further comprises an acoustic sensing device.

21. The method of claim 12, further comprising the step of:
e) accessing said control circuit remotely via a communication circuit.

22. An apparatus for reducing energy consumption, said apparatus comprising:
at least one occupancy detection device for generating an occupancy signal that is representative of an occupancy of a monitored zone;
at least one relay for being disposed along a heating, ventilation or cooling circuit, where said circuit includes a motorized damper and a thermostat having a thermostat setpoint; and
a control circuit, coupled to said at least one occupancy detection device, for receiving said occupancy signal and for causing said at least one relay to operate said motorized damper if said occupancy signal indicates that said monitored zone is unoccupied.

23. The apparatus of claim 22, further comprising a temperature circuit, coupled to said control circuit, for detecting a temperature setpoint that is different from said thermostat setpoint.

24. The apparatus of claim 23, wherein said at least one occupancy detection device comprises a first motion sensing device.

25. The apparatus of claim 24, wherein said at least one occupancy detection device comprises a second motion sensing device.

26. The apparatus of claim 23, wherein said at least one occupancy detection device comprises a light sensing device.

27. The apparatus of claim 24, wherein said at least one occupancy detection device further comprises a light sensing device.

28. The apparatus of claim 23, wherein said at least one occupancy detection device comprises an acoustic sensing device.

29. The apparatus of claim 24, wherein said at least one occupancy detection device further comprises an acoustic sensing device.

30. The apparatus of claim 26, wherein said at least one occupancy detection device further comprises an acoustic sensing device.

31. The apparatus of claim 37, wherein said at least one occupancy detection device further comprises an acoustic sensing device.

32. A method for reducing energy consumption, said method comprising the steps of:
a) providing at least one occupancy detection device for generating an occupancy signal that is representative of an occupancy of a monitored zone;
b) providing at least one relay for being disposed along a heating, ventilation or cooling circuit, where said circuit includes a motorized damper and a thermostat having a thermostat setpoint; and
c) providing a control circuit for receiving said occupancy signal and for causing said at least one relay to operate said motorized damper if said occupancy signal indicates that said monitored zone is unoccupied.

33. The method of claim 32, further comprising the step of:
d) providing a temperature circuit for detecting a temperature setpoint that is different from said thermostat setpoint.

34. The method of claim 33, wherein said at least one occupancy detection device comprises a first motion sensing device.

35. The method of claim 34, wherein said at least one occupancy detection device comprises a second motion sensing device.

36. The method of claim 33, wherein said at least one occupancy detection device comprises a light sensing device.

37. The method of claim 34, wherein said at least one occupancy detection device further comprises a light sensing device.

38. The method of claim 33, wherein said at least one occupancy detection device comprises an acoustic sensing device.

39. The method of claim 34, wherein said at least one occupancy detection device further comprises an acoustic sensing device.

40. The method of claim 36, wherein said at least one occupancy detection device further comprises an acoustic sensing device.

41. The method of claim 47, wherein said at least one occupancy detection device further comprises an acoustic sensing device.

42. The method of claim 33, further comprising the step of:
e) accessing said control circuit remotely via a communication circuit.
